(19) United States
(12) Patent Application Publication
(10) Pub. No.: US 2011/0157814 A1
(43) Pub. Date: Jun. 30, 2011

(54) NOTEBOOK COMPUTER WITH THERMAL INSULATING LAYER

(75) Inventor: YEN-CHIH CHEN, Tu-Cheng (TW)

(73) Assignee: FOXCONN TECHNOLOGY CO., LTD., Tu-Cheng (TW)

(21) Appl. No.: 12/765,804

(22) Filed: Apr. 22, 2010

(30) Foreign Application Priority Data
Dec. 30, 2009 (TW) 98145710

(51) Int. Cl. G06F 1/20

(52) U.S. Cl. 361/679.47; 361/679.54

(57) ABSTRACT

A notebook computer includes a bottom plate, a top cover, and an electronic component. The bottom plate and the top cover cooperatively define a receiving space therebetween. The electronic component is received in the receiving space and faces the top cover. A thermal insulating layer is attached to an inner surface of the top cover and located directly above the electronic component.

### BACKGROUND

1. Technical Field

The present disclosure relates to portable electronic devices, and particularly to a notebook computer with a thermal insulating layer.

2. Description of Related Art

With continuing developments in technology, notebook computers have become increasingly compact. Accordingly, a bottom plate of a notebook computer is often arranged close to a top plate of the notebook computer, with only a narrow space therebetween. Electronic components are often located on the bottom plate facing the top plate. Thus, heat generated by the electronic components can easily rise directly towards the top plate, increasing the temperature of locations of the top plate above the electronic components. Overheating of some of the electronic components may occur, and this may impair the operation or use of the notebook computer.

Therefore, a notebook computer that can overcome the described limitations is desired.

### BRIEF DESCRIPTION OF THE DRAWINGS

FIG. 1 is an assembled, isometric view of part of a notebook computer in accordance with an exemplary embodiment.

FIG. 2 is an exploded, isometric view of a part of the notebook computer shown in FIG. 1.

FIG. 3 is a cross-section of part of the notebook computer shown in FIG. 1, taken along a line III-III thereof.

FIG. 4 shows an initial stage in an exemplary method of applying insulating material on a top cover of the notebook computer shown in FIG. 1 to form a thermal insulating layer on the top cover.

FIG. 5 is similar to FIG. 4, but showing a later stage of the method, with the insulating material evenly applied on the top cover.

### DETAILED DESCRIPTION

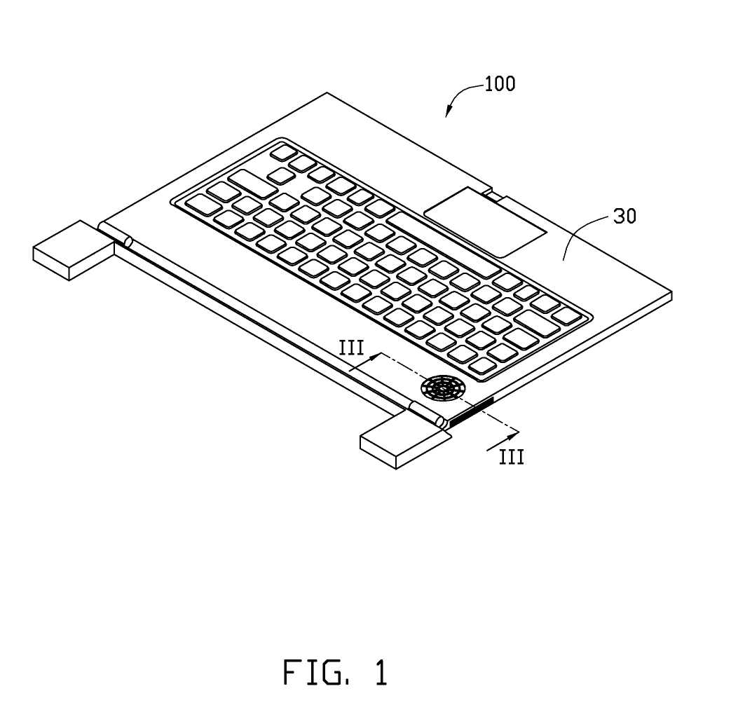

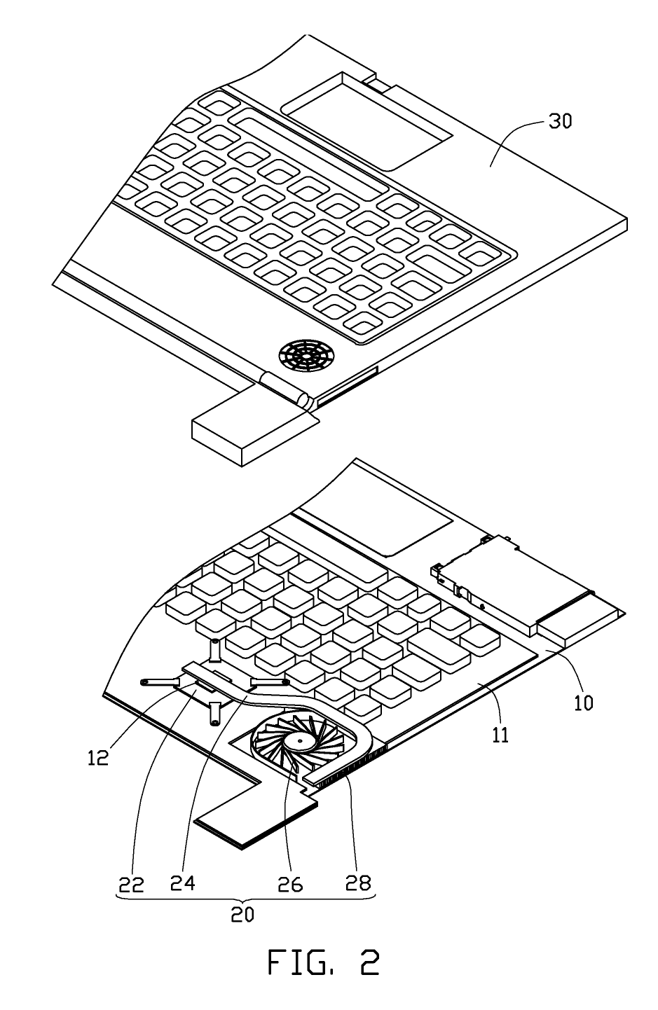

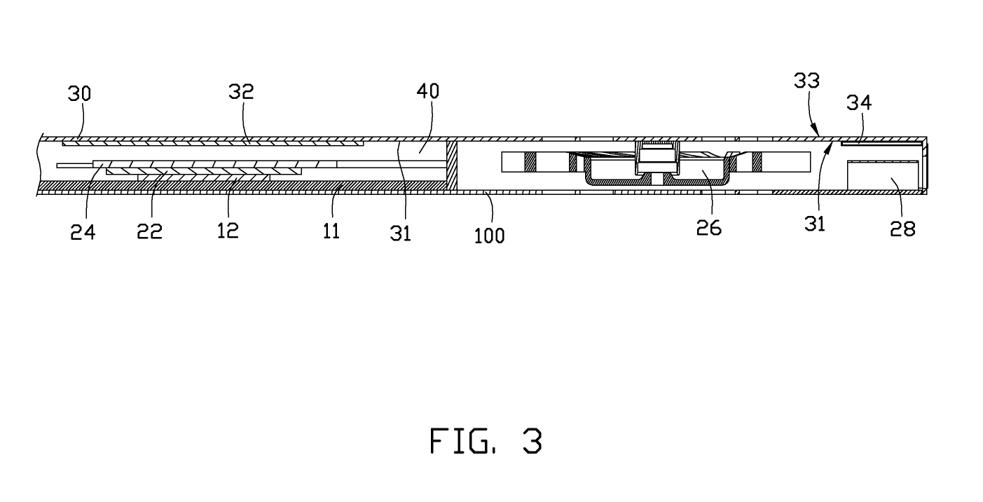

Referring to FIGS. 1-3, part of a notebook computer 100 according to an exemplary embodiment is shown. A display panel of the notebook computer 100 is not shown.

The notebook computer 100 includes a bottom plate 10 and a top cover 30 secured to and covering the bottom plate 10. The bottom plate 10 and the top cover 30 cooperatively define a receiving space 40 therebetween. A circuit board 11, an electronic component 12 such as a central processing unit (CPU) mounted on the circuit board 11, and a thermal module 20 thermally attached on the electronic component 12 are received in the receiving space 40 of the notebook computer 100. The thermal module 20 transfers heat generated by the electronic component 12 to an outside of the notebook computer 100.

The thermal module 20 includes a heat absorbing plate 22, a fin assembly 28, a heat pipe 24 connecting the heat absorbing plate 22 with the fin assembly 28, and a centrifugal fan 26 located adjacent to the fin assembly 28. The heat absorbing plate 22 is attached to the electronic component 12 to absorb heat therefrom. The heat pipe 24 transfers the heat to the fin assembly 28. The fin assembly 28 dissipates the heat into ambient air around the fin assembly 28, and the centrifugal fan 26 provides an airflow to remove the hot air around the fin assembly 28.

A first thermal insulating layer 32 and a second thermal insulating layer 34 are attached to an inner surface 31 of the top cover 30. The first and second thermal insulating layers 32, 34 are made of thermal insulating material with a low heat transfer coefficient, such as thermal isolation paint. The low heat transfer coefficient may be less than 0.2 W/m·k. A thickness of each of the first and second thermal insulating layers 32, 34 is between 0.3 mm (millimeters) and 0.5 mm. Thus, the first and second thermal insulating layers 32, 34 are thin such that the first and second thermal insulating layers 32, 34 occupy little space in the receiving space 40.

The first and second thermal insulating layers 32, 34 are attached to different positions of the inner surface 31 of the top cover 30. The first thermal insulating layer 32 is located directly above the electronic component 12, and the second thermal insulating layer 34 is located directly above the fin assembly 28. In the illustrated embodiment, an area of the first thermal insulating layer 32 is larger than a corresponding area of the electronic component 12; and an area of the second thermal insulating layer 34 is larger than a corresponding area of the fin assembly 28. A portion of the heat generated by the electronic component 12 is dissipated into the receiving space 40 directly by convection or radiation, and another portion of the heat generated by the electronic component 12 is transferred to the fin assembly 28 by the heat pipe 24. Air around the electronic component 12 and air around the fin assembly 28 in the receiving space 40 are heated respectively by the electronic component 12 and the fin assembly 28, and such heated air moves upwardly towards the top cover 30. Thus, the top cover 30 is heated.

However, since the first and second thermal insulating layers 32, 34 are attached to the inner surface 31 of the top cover 30 and located directly above the electronic component 12 and the fin assembly 28, respectively, the first and second thermal insulating layers 32, 34 prevent much or most of the heat dissipated from the electronic component 12 and the fin assembly 28 from being transferred directly to the top cover 30. Therefore, the top cover 30 is substantially thermally isolated by the first and second thermal insulating layers 32, 34, and as a result, the temperature of the top cover 30 can stay low.

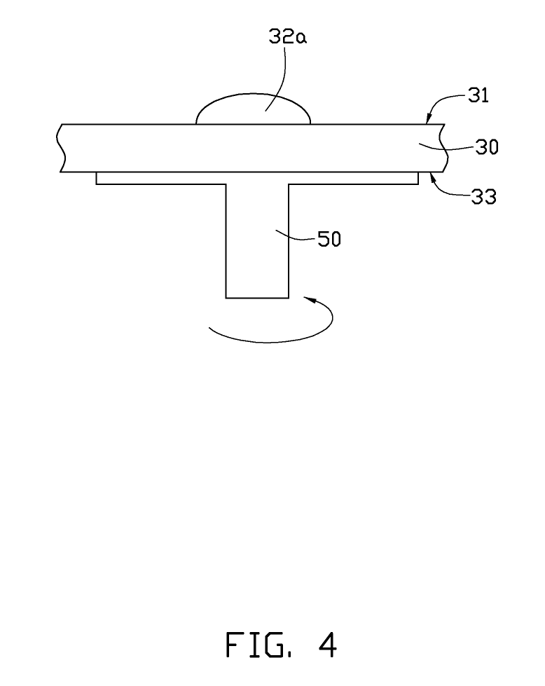

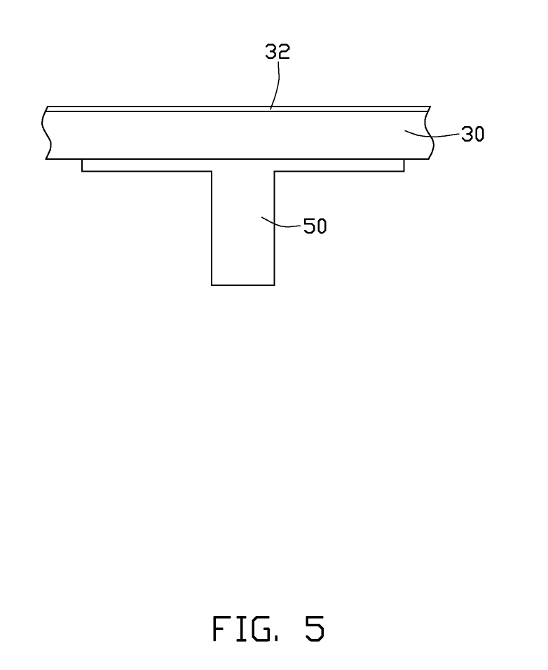

Referring to FIGS. 4 and 5, in an exemplary method of forming the first thermal insulating layer 32, the top cover 30 is fixed on a spinning machine 50. In particular, an outer surface 33 of the top cover 30 is attached to the spinning machine 50, and the inner surface 31 of the top cover 30 faces upward. Insulating material 32a with a low heat transfer coefficient, in the form of a paste, is provided. The insulating material 32a is applied to the inner surface 31 of the top cover 30. When the spinning machine 50 rotates at a high speed, with the top cover 30 rotating accordingly, the insulating material 32a is thus evenly applied on the inner surface 31 of the top cover 30 due to centrifugal force. The thickness of the applied insulating material 32a decreases with an increase in the rotation speed of the spinning machine 50. Then the top cover 30 with the insulating material 32a applied thereon is heated. The insulating material 32a is cured to become the first thermal insulating layer 32, which is firmly attached to the inner surface 31 of the top cover 30. The second thermal insulating layer 34 can also be formed on the inner surface 31 of the top cover 30 by the above-described method.

It is to be understood, however, that even though numerous characteristics and advantages of exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A notebook computer, comprising:
a bottom plate;
a top cover connected to the bottom plate with a receiving space defined therebetween;
an electronic component received in the receiving space and facing the top cover; and
a thermal insulating layer is attached to an inner surface of the top cover and located directly above the electronic component.

2. The notebook computer of claim 1, further comprising a thermal module received in the receiving space, the thermal module comprising a fin assembly and a heat pipe thermally connecting the fin assembly with the electronic component.

3. The notebook computer of claim 2, further comprising another thermal insulating layer attached to the inner surface of the top cover and located directly above the fin assembly of the thermal module.

4. The notebook computer of claim 3, wherein an area of the thermal insulating layer is larger than a corresponding area of the electronic component, and an area of the another thermal insulating layer is larger than a corresponding area of the thermal module.

5. The notebook computer of claim 1, wherein the thermal insulating layer is made of material with a low heat transfer coefficient less than 0.2 W/m·k.

5. The notebook computer of claim 5, wherein the insulating material is thermal isolation paint.

6. The notebook computer of claim 1, wherein the thermal insulating layer has a thickness between 0.3 mm and 0.5 mm.

7. A notebook computer, comprising:
a bottom plate;
a top cover connected to the bottom plate with a receiving space defined therebetween;
an electronic component received in the receiving space and facing the top cover;
a thermal module received in the receiving space and comprising a fin assembly and a heat pipe thermally connecting the fin assembly with the electronic component;
a first thermal insulating layer applied to an inner surface of the top cover and located directly above the electronic component; and
a second thermal insulating layer applied to the inner surface of the top cover and located directly above the fin assembly.

8. The notebook computer of claim 7, wherein an area of the first thermal insulating layer is larger than a corresponding area of the electronic component, and an area of the second thermal insulating layer is larger than a corresponding area of the thermal module.

9. The notebook computer of claim 7, wherein the thermal insulating layer is made of material with a low heat transfer coefficient less than 0.2 W/m·k.

10. The notebook computer of claim 9, wherein the insulating material is thermal isolation paint.

11. The notebook computer of claim 7, wherein the first and second thermal insulating layers each have a thickness between 0.3 mm and 0.5 mm.
